(19) United States
(12) Patent Application Publication
(10) Pub. No.: US 2007/0188925 A1
(43) Pub. Date: Aug. 16, 2007

(54) Flying head slider having depression surrounded by air bearing surface

(75) Inventor: Nobuhiko Ishihara, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/429,156

(22) Filed: May 8, 2006

(30) Foreign Application Priority Data
Feb. 16, 2006 (JP) 2006-038890

(51) Int. Cl. G11B 5/60

(52) U.S. Cl. 360/235.8; 360/235.6; 360/236.2; 360/236.3

(57) ABSTRACT

A recording disk drive includes a head actuator member supporting a flying head slider at its tip end. The head actuator member takes off form a ramp member outside the recording disk when the rotation of the recording disk has entered a steady condition. The flying head slider thus receives airflow generated along the moving surface of the recording disk. The airflow serves to generate a negative pressure on the flying head slider when the head actuator member is disengaged from the ramp member. The flying head slider is forced to get closer to the surface of the recording disk. In this case, the airflow flows into a depression surrounded by an air bearing surface. The airflow bounces back at the bottom of the depression. Such airflow serves to increase the lift on the flying head slider. The flying head slider is prevented from collision against the recording disk.

### BACKGROUND OF THE INVENTION

1. Field of the Invention

The present invention relates to a recoding disk drive such as a hard disk drive, HDD, for example. In particular, the invention relates to a recording disk drive including a flying head slider opposed to the surface of a recording disk, a head actuator member designed to support the flying head slider on its tip end, and a ramp member positioned outside the recording disk for receiving the head actuator member.

2. Description of the Prior Art

A hard disk drive includes a head actuator member, namely a carriage, designed to support a flying head slider on its tip end, for example. The carriage is received on a ramp member positioned outside the magnetic recording disk. The carriage is designed to take off from the ramp member toward the magnetic recording disk during the rotation of the magnetic recording disk. The flying head slider opposes its bottom surface to the surface of the rotating magnetic recording disk. The airflow acts on the bottom surface. Rails formed on the bottom surface serve to generate a positive pressure or lift and a negative pressure on the flying head slider. The flying attitude is established based on the balance between the lift and the negative pressure.

The generation of a negative pressure precedes the generation of the lift on the flying head slider, when the carriage takes off from the ramp member. Such a negative pressure forces the flying head slider to move toward the surface of the rotating magnetic recording disk. The flying head slider tends to often collide against the surface of the rotating magnetic recording disk. The flying head slider and the magnetic recording disk thus get damaged.

### SUMMARY OF THE INVENTION

It is accordingly an object of the present invention to provide a recording disk drive capable of reliably preventing a collision between a flying head slider and a recording disk. It is an object of the present invention to provide a flying head slider greatly contributing to the realization of the recording disk drive.

According to the present invention, there is provided a recording disk drive comprising: a recording disk; a flying head slider opposed to the surface of the recording disk; a head actuator member supporting the flying head slider on its tip end; and a ramp member placed at a position outside the recording disk, the ramp member designed to receive the head actuator member. The flying head slider comprises: a slider body defining a base surface opposed to the surface of the recording disk; a rail formed on the base surface and standing from the base surface; an air bearing surface defined on the rail; and a depression formed on the rail and surrounded by the air bearing surface.

The head actuator member moves toward the recording disk from the ramp member when the rotation of the recording disk has entered a steady condition. The flying head slider receives airflow generated along the moving surface of the recording disk. The airflow serves to generate a negative pressure on the flying head slider when the head actuator member is disengaged from the ramp member. The flying head slider is forced to get closer to the moving surface of the recording disk. In this case, the airflow flows into the depression. The airflow bounces back at the bottom of the depression since the depression is surrounded by the air bearing surface. The airflow flows out of the depression towards the recording disk. Such airflow serves to increase the lift on the flying head slider. The flying head slider is prevented from collision against the recording disk. The flying head slider and the recording disk are thus reliably prevented from getting damaged.

The depression may have the bottom surface designed to extend within a plane including the base surface. Milling is effected on the surface of the slider body in a method of making the flying head slider. A photoresist may be formed on the surface of the slider body prior to milling, for example. The photoresist defines voids corresponding to the shapes or contours of the base surface and the depression. The milling serves to remove the material of the slider body around the photoresist. The milling serves to concurrently form the base surface and the depression on the bottom surface. A conventional method of making may be utilized to form the depression if the shape or contour of the photoresist is correspondingly adjusted.

A specific flying head slider may be provided to realize the aforementioned recording disk drive. The flying head slider may comprise: a slider body defining a base surface opposed to a recording disk; a rail formed on the base surface and standing from the base surface; an air bearing surface defined on the rail; and a depression formed on the rail and surrounded by the air bearing surface.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive as an example of a recording disk drive according to the present invention;

FIG. 2 is an enlarged perspective view,of a ramp member;

FIG. 3 is an enlarged perspective view of a flying head slider according to a specific example of the present invention;

FIG. 4 is an enlarged sectional view showing the depth of the depression;

FIG. 5 is a sectional view taken along the line 5-5 in FIG. 1;

FIG. 6 is an enlarged sectional view, corresponding to FIG. 4, schematically illustrating airflow flowing into the depression;

FIG. 7 is a graph showing the flying height of a conventional flying head slider when a head suspension is disengaged from the ramp member;

FIG. 8 is a graph showing the flying height of the flying head slider according to an embodiment of the present invention when a head suspension is disengaged from the ramp member; and

FIG. 9 is an enlarged perspective view of a flying head slider according to another example of the present invention.

### DESCRIPTION OF THE PREFERRED EMBODIMENTS

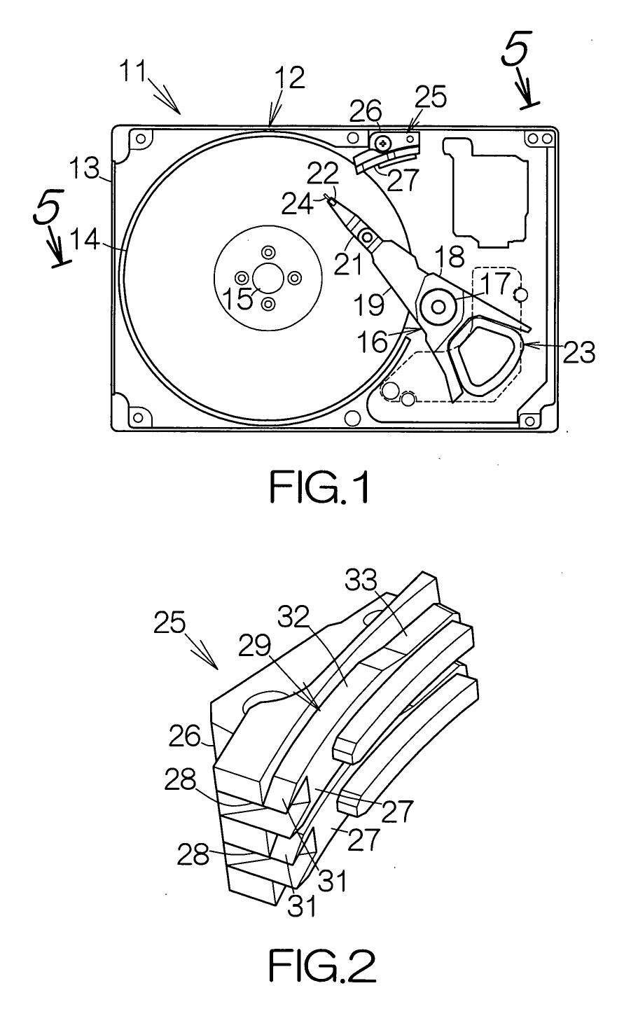

FIG. 1 schematically illustrates the inner structure of a hard disk drive, HDD, 11 as a specific example of a recoding disk drive according to an embodiment of the present invention. The hard disk drive 11 includes a box-shaped enclosure 12. The enclosure 12 includes a box-shaped base 13 defining an inner space of a flat parallelepiped opened upward, for example. The base 13 may be made of a metallic material such as aluminum, for example. Molding process may be employed to form the base 13. A cover, not shown, is coupled to the base 13. The cover serves to close the opening of the base 13. Pressing process may be employed to form the cover out of a plate, for example.

At least one magnetic recording disk 14 as a recording medium is enclosed within the inner space of the base 13. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A head actuator member, namely a carriage 16 is also enclosed within the inner space of the base 13. The said carriage 16 includes a carriage block 18 supported on a vertical support shaft 17 for relative rotation. Carriage arms 19 are defined in the carriage block 18. The carriage arms 19 are designed to extend in the horizontal direction from the support shaft 17. The carriage block 18 may be made of aluminum, for example. Molding process may be employed to form the carriage block 18.

An elastic head suspension 21 is fixed to the tip end of the individual carriage arm 19. The head suspension 21 is designed to extend forward from the tip end of the carriage arm 19. A gimbal spring, not shown, is connected to the tip end of the individual head suspension 21. A flying head slider 22 is fixed to the surface of the gimbal spring. The gimbal spring allows the flying head slider 22 to change its attitude relative to the head suspension 21.

An electromagnetic transducer, not shown, is mounted on the flying head slider 22. The electromagnetic transducer may include a write element and a read element. The write element may include a thin film magnetic head designed to write magnetic information data into the magnetic recording disk 14 by utilizing a magnetic field induced at a thin film coil pattern. The read element may include a giant magnetoresistive (GMR) element or a tunnel-junction magnetoresistive (TMR) element designed to discriminate magnetic bit data on the magnetic recording disk 14 by utilizing variation in the electric resistance of a spin valve film or a tunnel-junction film, for example.

The head suspension 21 serves to urge the flying head slider 22 toward the surface of the magnetic recording disk 14. When the magnetic recording disk 14 rotates, the flying head slider 22 is allowed to receive an airflow generated along the rotating magnetic recording disk 14. The airflow serves to generate a positive pressure or a lift on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the lift.

When the carriage 16 is driven to swing around the support shaft 17 during the flight of the flying head slider 22, the flying head slider 22 is allowed to move in the radial direction of the magnetic recording disk 14. The electromagnetic transducer on the flying head slider 22 is thus allowed to cross the data zone defined between the innermost and outermost recording tracks. The electromagnetic transducer can thus be positioned right above a target recording track on the magnetic recording disk 14. A power source such as a voice coil motor, VCM, 23 may be employed to realize the swinging movement of the carriage 16.

A load tab 24 is attached to the front or tip end of the head suspension 21so as to further extend in the forward direction from the head suspension 21. The load tab 24 is allowed to move in the radial direction of the magnetic recording disk 14 based on the swinging movement of the carriage 16. A ramp member 25 is located at a position outside the magnetic recording disk 14 on the movement path of the load tabs 24. The ramp member 25 extends toward a position inside the outer periphery of the magnetic recording disk 14, so that the tip end of the ramp member 25 is opposed to the non-data zone outside the outermost recording track. The combination of the load tab 24 and the ramp member 25 establishes a so-called load/unload mechanism. The ramp member 25 may be made of a hard plastic material, for example. Molding process may be employed to form the ramp member 25.

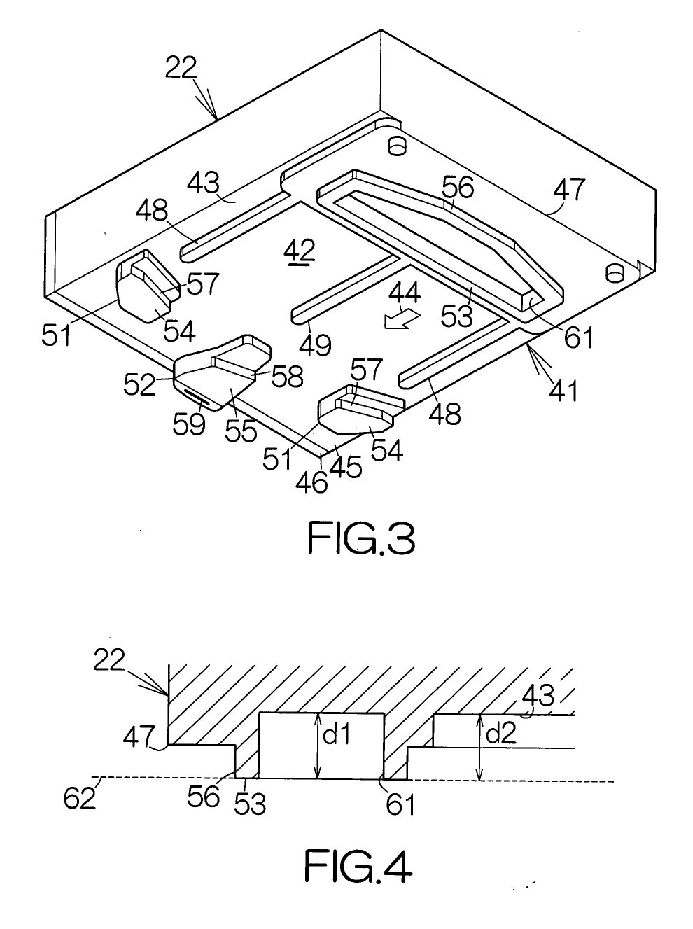

Referring also to FIG. 2, the ramp member 25 includes an attachment base 26 fixed to the bottom plate of the base 13 at a position outside the magnetic recording disk 14, for example. A screw may be employed to fix the attachment base 26. The attachment base 26 stands upright in the vertical direction from the lowest end received on the bottom plate of the base 13. The attachment base 26 defines a side wall surface standing upright from the bottom plate of the base 13. Protrusions 27 are formed on the side wall surface of the attachment base 26. The protrusions 27 are designed to extend in the horizontal direction from the attachment base 26 toward the support shaft 17 of the carriage 16. The protrusions 27 are assigned to the respective magnetic recording disks 14. The protrusions 27 are coupled to the attachment base 26 based on integral molding, for example. A receiving depression 28 is defined in each of the protrusions 27 so as to extend into the attachment base 26. The receiving depressions 28 is designed to receive a corresponding one of the magnetic recording disks 14.

A sliding surface 29 is defined on the protrusion 27 between the inner and outer ends of the protrusion 27 along the movement path of the load tab 24. The sliding surface 29 includes an inclined surface 31 at a location closest to the outermost recording track on the magnetic recording disk 14. The inclined surface 31 gets remoter from the magnetic recording disk 14 at a position remoter from the outermost recording track. A first flat surface 32 is connected to the highest or outer end of the inclined surface 31. The first flat surface 32 extends outward from the inclined surface 31 along the path of movement of the load tab 24. A second flat surface 33 is connected to the outer end of the first flat surface 32. The second flat surface 33 extends outward from the first flat surface 32 along the path of movement of the load tab 24. The second flat surface 33 is arranged at a level lower than the level of the first flat surface 32. In other words, the second flat surface 33 is located closer to a horizontal plane including the surface of the magnetic recording disk 14 rather than the first flat surface 32. An inclined flat surface is employed to connect the inner end of the second flat surface 33 to the outer end of the first flat surface 32.

FIG. 3 illustrates the flying head slider 22 according to a specific example. The flying head slider 22 includes a slider body 41 in the form of a flat parallele piped, for example. The slider body 41 is designed to oppose a medium-opposed surface, namely a bottom surface 42 to the magnetic recording disk 14. A flat base surface 43 is defined on the bottom surface 42. When the magnetic recording disk 14 rotates, airflow 44 is allowed to flow along the bottom surface 42 from the front or leading end to the back or trailing end of the slider body 41. The slider body 41 may include a base material made of Al₂O₃—TiC, for example, and a Al₂O₃ (Alumina) film 46 overlaid on the outflow end surface of the base material 45.

A stripe of a front rail 47 is formed on the bottom surface 42 of the slider body 41 at a position near the inflow end of the slider body 41. The front rail 47 extends on the base surface 43 along the inflow end of the slider body 41. A pair of side rails 48, 48 is also formed on the bottom surface 42. The respective side rails 48 extend downstream in the direction of the airflow 44 from the rear end of the front rail 47 along the side edges of the slider body 41. A stripe of a center rail 49 is also formed on the bottom surface 42. The center rail 49 likewise extends downstream from the rear end of the front rail 47 in a space between the side rails 48. The side rails 48 and the center rail 49 may extend in parallel with one another.

A pair of rear side rails 51, 51 is formed on the bottom surface 42. The respective rear side rails 51 extend on the base surface 43 along the side edges of the slider body 41 at positions near the outflow end of the slider body 41. A rear center rail 52 is also formed on the bottom surface 42 at a position near the outflow end of the slider body 41. The rear center rail 52 extends on the base surface 43 in a space between the rear side rails 51, 51. Here, the top surfaces of the rails 47, 48, 49, 51 and 52 may be included in a common plane parallel to the base surface 43.

Air bearing surfaces 53, 54, 55 are respectively defined on the top surfaces of the front rail 47, the rear side rails 51 and the rear center rail 52. Steps 56, 57, 58 are defined at the inflow ends of the air bearing surfaces 53, 54, 55. The steps 56, 57, 58 serve to connect the air bearing surfaces 53, 54, 55 to the corresponding top surfaces of the rails 47, 51, 52. Here, the steps 56, 57, 58 may have the same height. In other words, the air bearing surfaces 53, 54, 55 may be included in a common plane parallel to the base surface 43.

The aforementioned electromagnetic transducer, namely a read/write head element 59 is mounted on the slider body 41. The read/write head element 59 is embedded within the alumina film 46 of the slider body 41. A read gap and a write gap of the read/write head element 59 are exposed at the air bearing surface 55 of the rear center rail 52. It should be noted that a DLC (Diamond-Like-Carbon) protection film may cover over the exposed front end of the read/write head element 59.

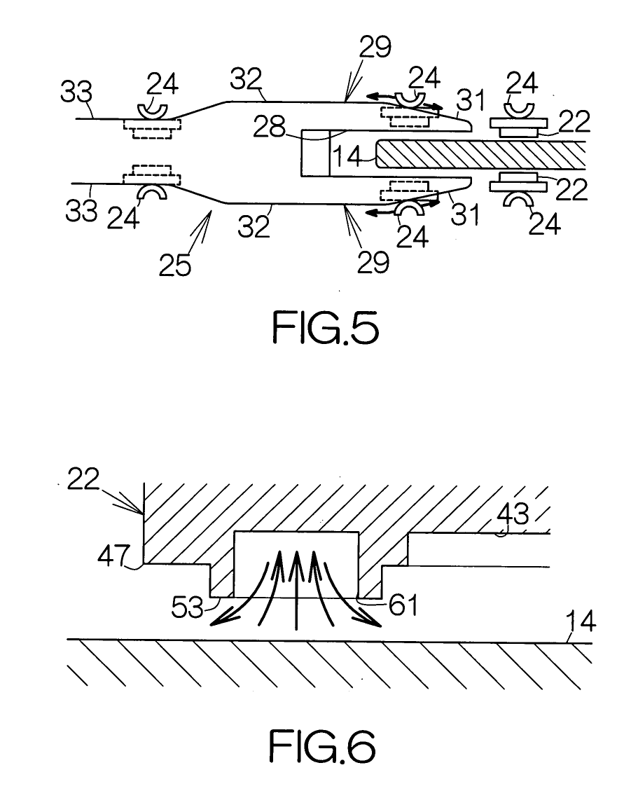

A depression 61 is formed on the front rail 47. The air bearing surface 53 seamlessly surrounds the depression 61. The depression 61 has a constant depth from the air bearing surface 53, for example. Here, the depression 61 forms a groove extending in parallel with the inflow end of slider body 41. The opening of the depression 61 may have a size depending on a required volume of the airflow described later in detail. As shown in FIG. 4, a distance d1 is set between a plane 62 including the air bearing surface 53 (54, 55) and the bottom surface of the depression 61. The distance d1 is set equal to the distance d2 between the plane 62 and the base surface 43. The distance d1, d2 may be set at approximately 1-3 μm, for example.

When airflow is generated along the surface of the rotating magnetic recording disk 14, the bottom surface 42 receives the airflow. The steps 56, 57, 58 serve to generate a relatively large positive pressure or lift on the air bearing surfaces 53, 54, 55. A large negative pressure is also generated behind the front rail 47. The flying head slider 22 is allowed to take the flying attitude depending on the balance between the lift and the negative pressure. It should be noted that the flying head slider 22 may take any shape other than the aforementioned one.

Now, assume that the magnetic recording disk or disks 14 stop rotating. When the read/write operation has been completed, the voice coil motor 23 drives the carriage 16 in the normal direction around the support shaft 17. The carriage arms 19 and the head suspensions 21 are driven outward the magnetic recording disk or disks 14. As shown in FIG. 5, when the flying head slider 22 gets opposed to the landing zone or non-data zone outside the outermost recording track, the load tab 24 contacts with the inclined surface 31 of the sliding surface 29. A further swinging movement of the carriage arms 19 allows the load tabs 24 to climb up the inclined surfaces 31. The upward movement of the load tabs 24 along the inclined surfaces 31 allows the tip ends of the head suspensions 21 to get distanced from the corresponding surfaces of the magnetic recording disk or disks 14. When the gimbal spring engages with the head suspension 21, the flying head slider 22 is lifted up from the surface of the magnetic recording disk 14.

When the carriage arms 19 further swing, the load tabs 24 slide on the first and second flat surfaces 32, 33. When the load tabs 24 reach the farthest position from the magnetic recording disk or disks 14, the flying head sliders 22 are positioned at the inoperative position. The load tabs 24 are in this manner received on the ramp member 25. The magnetic recording disk or disks 14 then stop rotating. Since the load tabs 24 are reliably held on the ramp member 25, the flying head sliders 22 are surely prevented from contact or collision against the magnetic recording disk or disks 14 even without any airflow acting on the flying head sliders 22. The flying head sliders 22 are thus effectively prevented from any attachment to a lubricant agent covering over the corresponding surfaces of the magnetic recording disk or disks 14.

When the hard disk drive 11 receives instructions for the read/write operation, the magnetic recording disk or disks 14 first start rotating. The voice coil motor 23 drives the carriage 16 around the support shaft 17 in the reverse direction opposite to the normal direction after the rotation of the magnetic recording disk or disks 14 have entered a steady condition. The carriage arms 19 and the head suspensions 21 are driven toward the rotation axis of the magnetic recording disk or disks 14. The individual load tab 24 is forced to slide on the second and first flat surfaces 33, 32 and the inclined surface 31 in this sequence. The load tabs 24 move downward along the corresponding inclined surfaces 31 based on the swinging movement of the carriage arms 19. The individual flying head slider 22 gets opposed to the surface of the magnetic recording disk 14 during the downward movement of the load tab 24 along the inclined surface 31. The flying head slider 22 receives airflow generated along the surface of the rotating magnetic recording disk 14.

When the carriage arms 19 further swing, the load tabs 24 take off from the inclined surfaces 31 or the ramp member 25. The airflow serves to generate a negative pressure at the bottom surface 42 of the flying head slider 22. Such a negative pressure exhibits a force to bring the flying head slider 22 closer to the surface of the rotating magnetic recording disk 14. In this case, the airflow flows into the depression 61, as shown in FIG. 6. Since the depression 61 is surrounded by the air bearing surface 53, the airflow thus bounces back at the bottom surface. The airflow flows out towards the surface of the magnetic recording disk 14. This airflow serves to increase the lift of the head slider 22. The flying head slider 22 is thus prevented from collision with the magnetic recording disk 14 as much as possible. The head slider 22 and the magnetic recording disk 14 are accordingly prevented from getting damaged. The steady rotation of the magnetic recording disk allows the flying head slider 22 to take the flying attitude depending on the balance between the lift and the negative pressure. The depression 61 hardly influences the flying attitude of the flying head slider 22. The flying head slider 22 is allowed to keep flying above the surface of the magnetic recording disk 14 even without a support of the ramp member 25.

A wafer made of Al₂O₃—TiC is first prepared in a method of making the aforementioned flying head slider 22. The alumina film 46 is formed on the surface of the wafer. The read/write head elements 59 are embedded within the alumina film 46. Wafer bars, including a row of the read/write head elements 59, are then cut out from the wafer. Milling is effected on the surface of the wafer bar. A photoresist is formed on the surface of the wafer bar prior to milling. The photoresist defines voids corresponding to the shapes of the base surface 43 and the depression 61. The Al₂O₃—TiC is removed at positions off the photoresist. The distance d1 is set equal to the distance d2 in the flying head sliders 22 as mentioned above, so that the depression 61 and the base surface 43 are concurrently formed in the wafer bar. A conventional method of making may be utilized to form the depression 61 if the shape or contour of the photoresist is correspondingly adjusted.

The inventors have observed the effect of the aforementioned depression 61 based on a simulation on a computer. The inventors prepared models corresponding to an embodiment of the present invention and a comparative example. The aforementioned flying head slider 22 was employed as the embodiment. A conventional flying head slider was employed as the comparative example. The depression 61 was omitted in the conventional flying head slider. The conventional flying head slider had the structure identical to that of the flying head slider 22 except the depression 61. The flying height of the flying head sliders was evaluated when the load tab takes off from the ramp member.

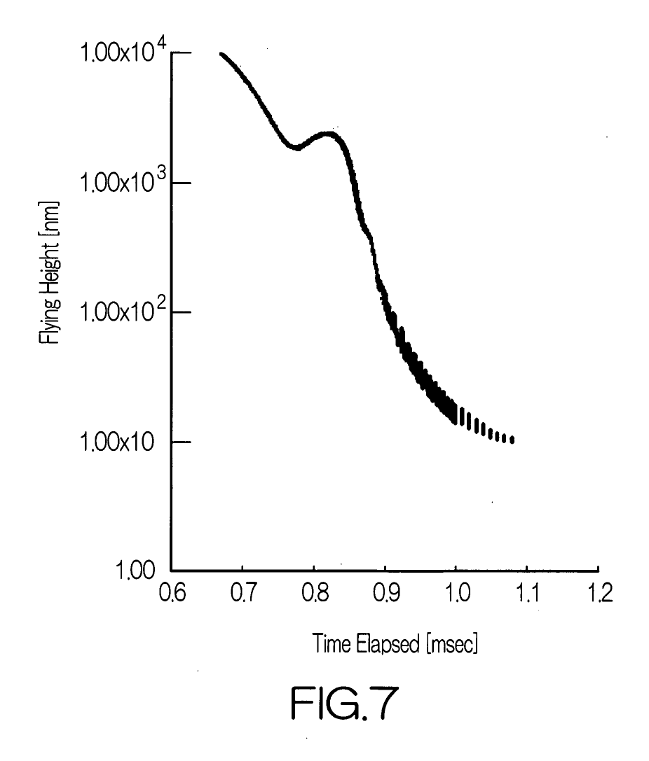

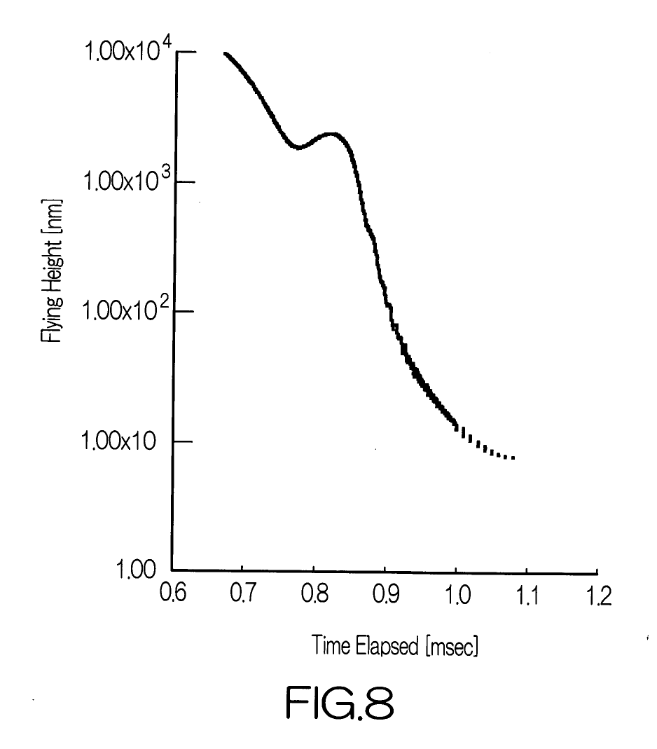

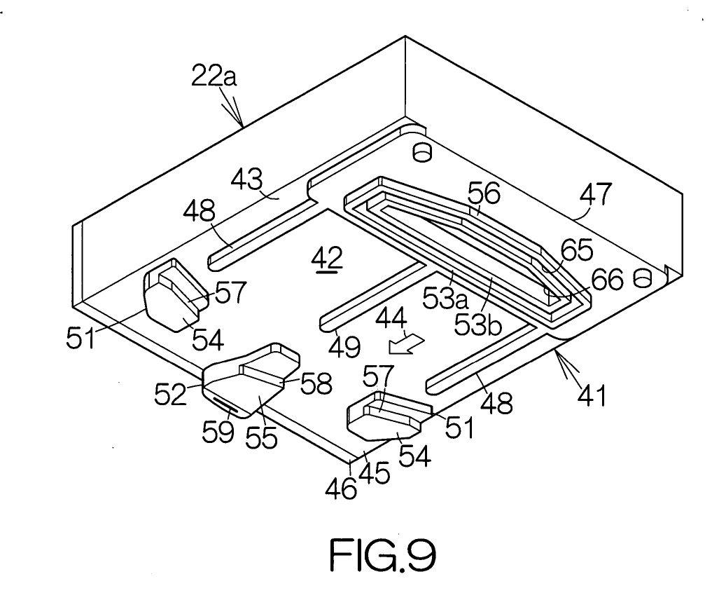

As shown in FIG. 7, it was revealed that the conventional flying head slider suffers from up-and-down movements when the flying height of the flying head slider falls between 1.10×1² [nm] and 1.00×10 [nm] during the disengagement from the ramp member 25. It was observed that the flying head slider 22 only suffers from reduced up-and-down movements when the flying height of the flying head slider 22 falls between 1.00×10² [nm] and 1.00×10 [nm], as shown in FIG. 8. In these cases, the flying height of 1.00×10 [nm] is the normal flying height during the rotation of the magnetic recording disk 14. It has been verified that the flying head slider 22 is allowed to enjoy an improved stability.

As shown in FIG. 9, the flying head slider 22a may include first and second depressions 65, 66, in place of the aforementioned depression 61 according to another embodiment of the present invention. In this case, a first air bearing surface 53a seamlessly surrounds the first depression 65 on the front rail 47. The second depression 66 is placed inside the second depression 65. A second air bearing surface 53b likewise seamlessly surrounds the second depression 66 inside the first depression 65 on the front rail 47. The first depression 65 seamlessly surrounds the second air bearing surface 53b. A distance is set between the bottom surface of the first and second depressions 65, 66 and the plane 62 including air bearing surfaces 53a, 53b (54, 55). Such a distance is set equal to the distance between the plane 62 and the base surface 43. Like reference numerals are attached to structure and components equivalent to those of the aforementioned embodiment. The flying head slider 22a allows the first and second depressions 65, 66 to contribute to a dispersed generation of a lift.

What is claimed is:

1. A recording disk drive comprising:
a recording disk;
a flying head slider opposed to a surface of the recording disk;
a head actuator member supporting the flying head slider on its tip end; and
a ramp member placed at a position outside the recording disk, the ramp member designed to receive the head actuator member, wherein
said flying head slider comprises:
a slider body defining a base surface opposed to the surface of the recording disk;
a rail formed on the base surface and standing from the base surface;
an air bearing surface defined on the rail; and
a depression formed on the rail and surrounded by the air bearing surface.

2. The recording disk drive according to claim 1, wherein said depression has a bottom surface designed to extend within a plane including the base surface.

3. A flying head slider comprising:
a slider body defining a base surface opposed to a recording disk;
a rail formed on the base surface and standing from the base surface;
an air bearing surface defined on the rail; and
a depression formed on the rail and surrounded by the air bearing surface.

4. The flying head slider according to claim 3, wherein said depression has a bottom surface extending within a plane including the base surface.
